(19) United States
(12) Patent Application Publication
(10) Pub. No.: US 2004/0221962 A1
(43) Pub. Date: Nov. 11, 2004

(54) Horizontal labeling machine

(76) Inventor: Nan-Yuan Haung, Hsinchu (TW)

Correspondence Address: BIRCH STEWART KOLASCH & BIRCH, PO BOX 747, FALLS CHURCH, VA, 22040-0747, US

(21) Appl. No.: 10/429,887

(22) Filed: May 6, 2003

(51) Int. Cl. B32B 31/00; B44C 1/00

(52) U.S. Cl. 156/538; 156/510; 156/540

(57) ABSTRACT

An improved horizontal labeling machine comprises a shrinkable film drum, a tension device, a shrinkable film guide device, a movable base, a cutting device, a high-speed wheel, a conveying wheel, a feeding device, a conveying groove, and a thermal shrinking device. The packing object is placed horizontally in the feeding device while the shrinkable film is sent to a central guide pillar by a shrinkable film conveying device. The shrinkable film is spread out for the cutting by the cutting device, and the shrinkable film is sent to the conveying wheel by the high-speed wheel and then wrapped onto the packing object. The wrapped packing object is sent to the conveying groove and then to the thermal shrinking device for thermal shrinking. Such arrangement attains the effect of wrapping a shrinkable film onto the outer surface of a packing object.

### FIELD OF THE INVENTION

The present invention relates to an improved horizontal labeling machine, more particularly to a labeling machine for automatically sleeving a shrinkable label onto a packing object that cannot be placed vertically or is uneasy to be placed vertically.

### BACKGROUND OF THE INVENTION

The prior-art shrinkable labeling machine generally has a vertical design, and comprises a machine frame, a central guide pillar and a cutting module are disposed at the center of the machine frame and enclosed by a box body, a shrinkable film drum disposed on one side of the machine frame, a conveyor disposed under the machine frame, a heating device disposed on another side of the conveyor, such that the shrinkable film can be rolled into the shrinkable film drum and pulled onto each axle rod to pass through the central guide pillar in the box body; after the shrinkable film is cut by the cutting module, the cut shrinkable film will fall onto the outer surface of the packing object located in the conveyor; the conveyor sends the labeled packing object into the heating device for the thermal shrinking process in order to wrap a shrinkable film onto the outer surface of the packing object.

### SUMMARY OF THE INVENTION

The primary objective of the present invention is to provide an improved horizontal labeling machine for wrapping a shrinkable film on a packing object that cannot be or is uneasy to be placed vertically by means of a high-speed wheel to send the shrinkable film to the conveying wheel.

### BRIEF DESCRIPTION OF THE DRAWINGS

FIG. 1 is a perspective diagram of the present invention.

FIG. 2 is a side-view diagram of the present invention.

FIG. 3A is a top-view diagram of the tension device according to the present invention.

FIG. 3B is an illustrative diagram of the control guide wheel of FIG. 3A when it accelerates the conveying.

FIG. 3C is an illustrative diagram of the control guide wheel of FIG. 3A when it retards the conveying.

FIG. 4 is a perspective diagram of the central guide pillar of the present invention.

FIG. 5A is an illustrative diagram of the vertical fine-tune device of the present invention.

FIG. 5B is an illustrative diagram of the contraction and expansion fine-tune device of the present invention.

FIG. 6 is a perspective diagram of the disassembled parts of the feeding wheel of the present invention.

FIG. 7A is an illustrative diagram of the high-speed wheel of the present invention before the shrinkable film is sent.

FIG. 7B is an illustrative diagram of the high-speed wheel of the present invention after the shrinkable film is sent.

### DETAILED DESCRIPTION OF THE PREFERRED EMBODIMENTS

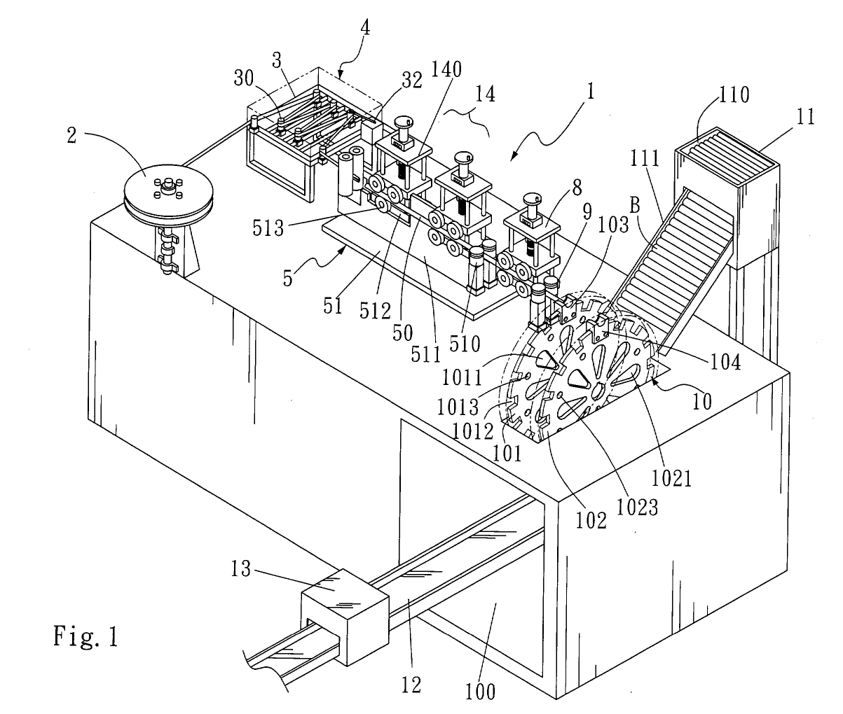

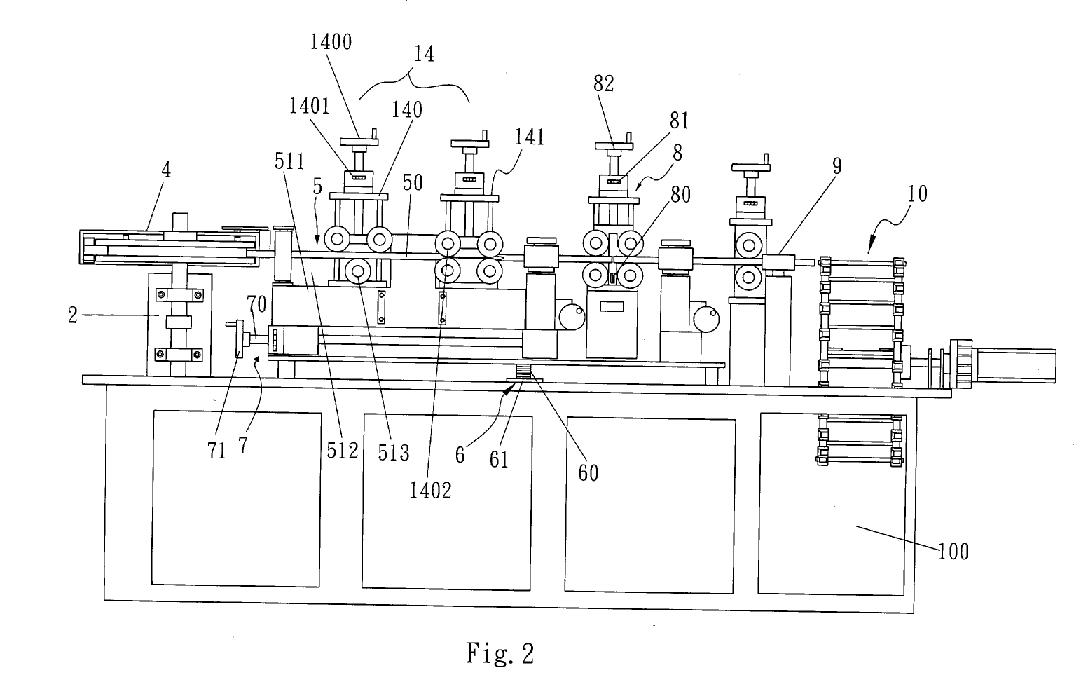

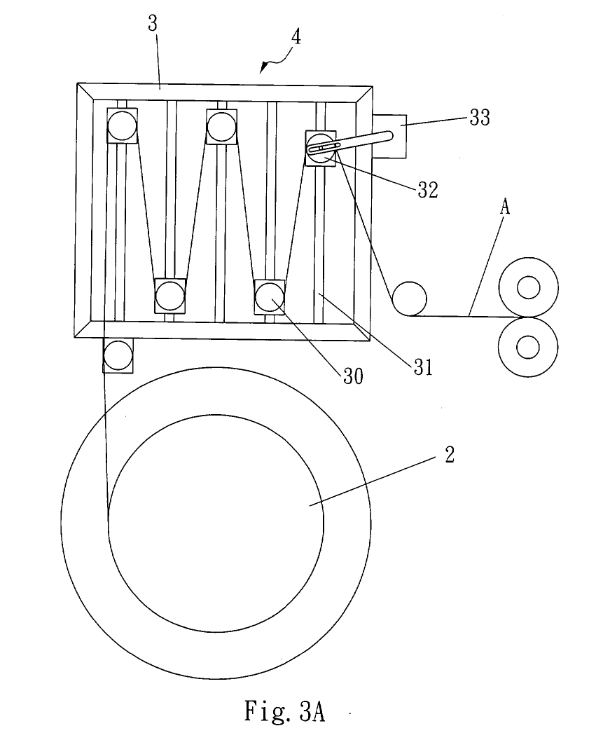

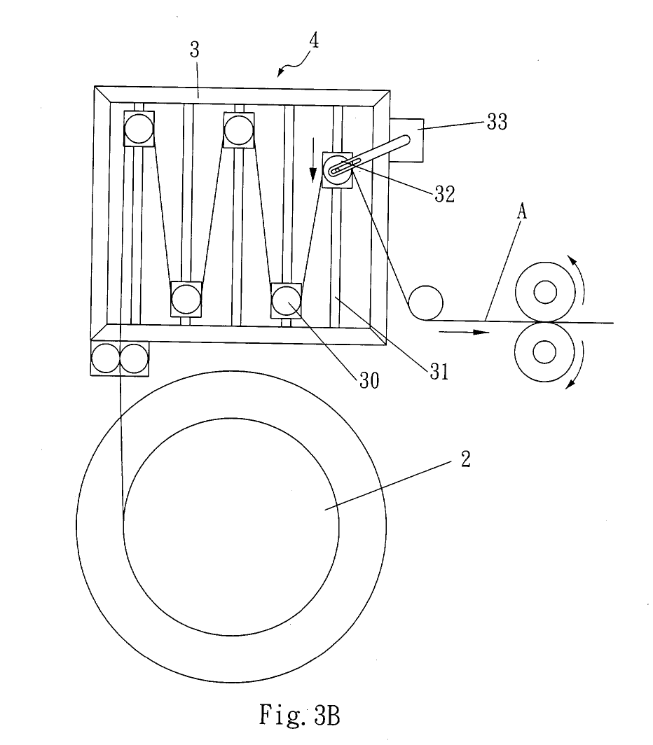

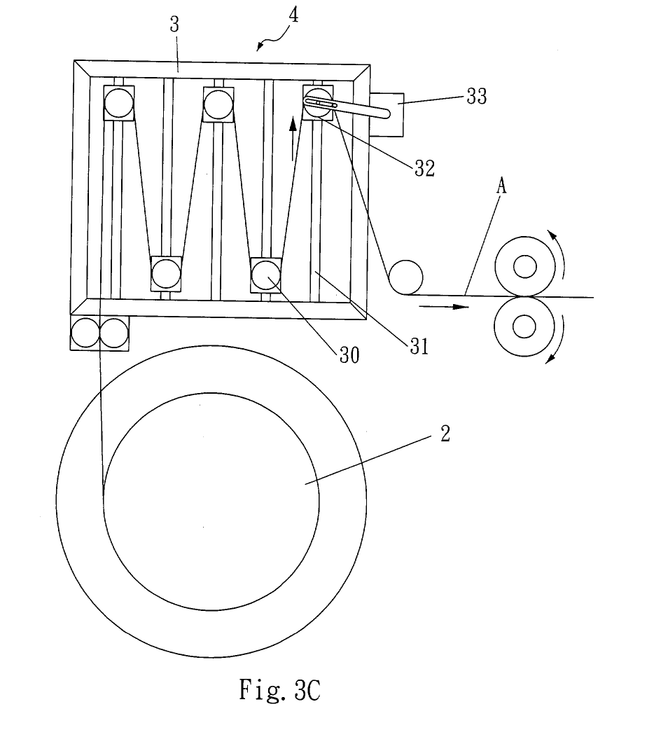

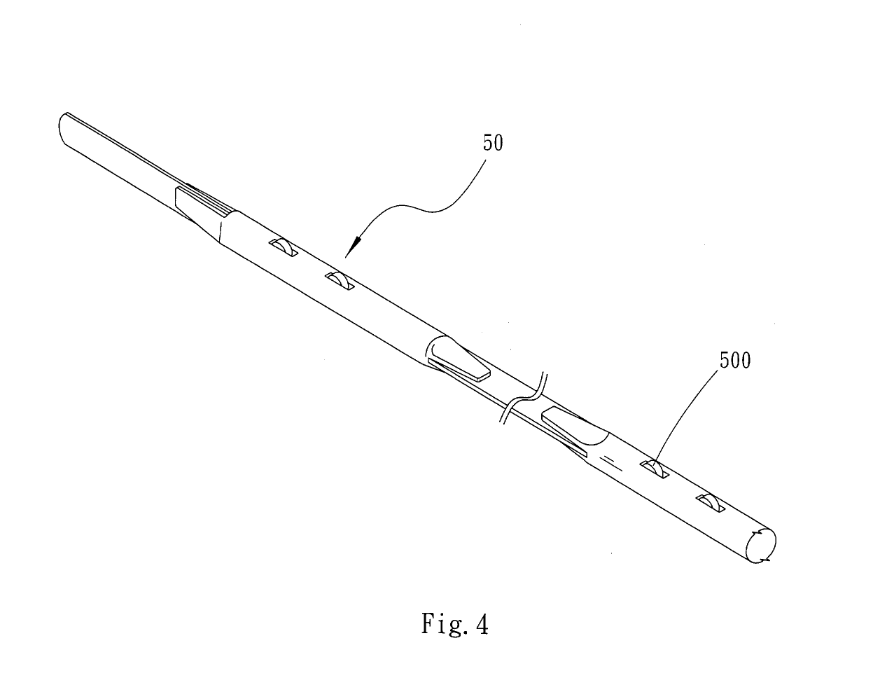

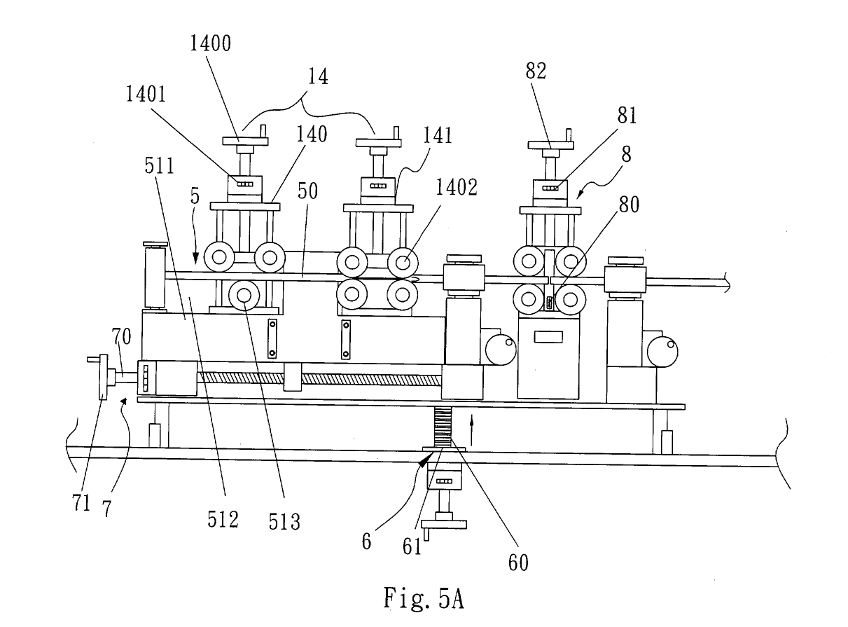

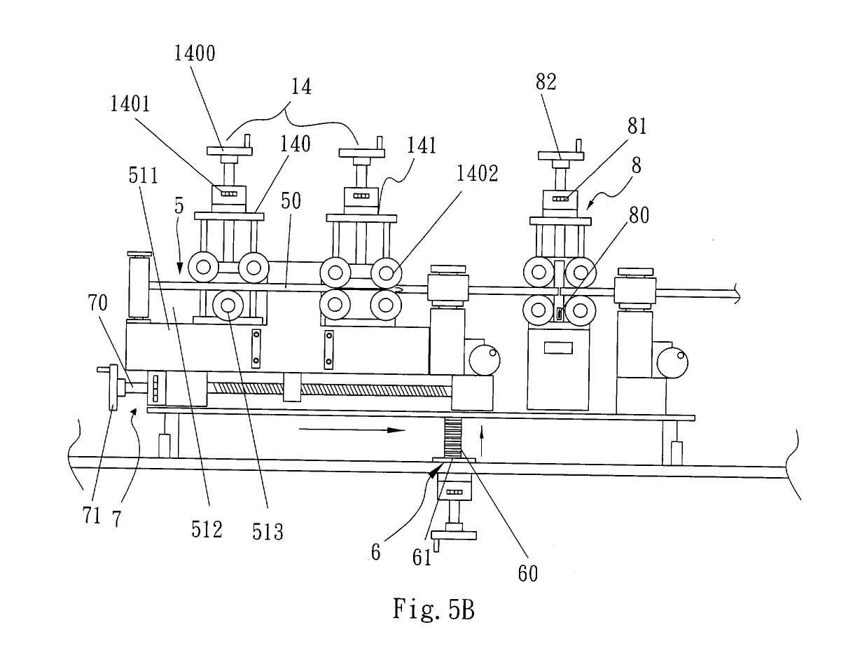

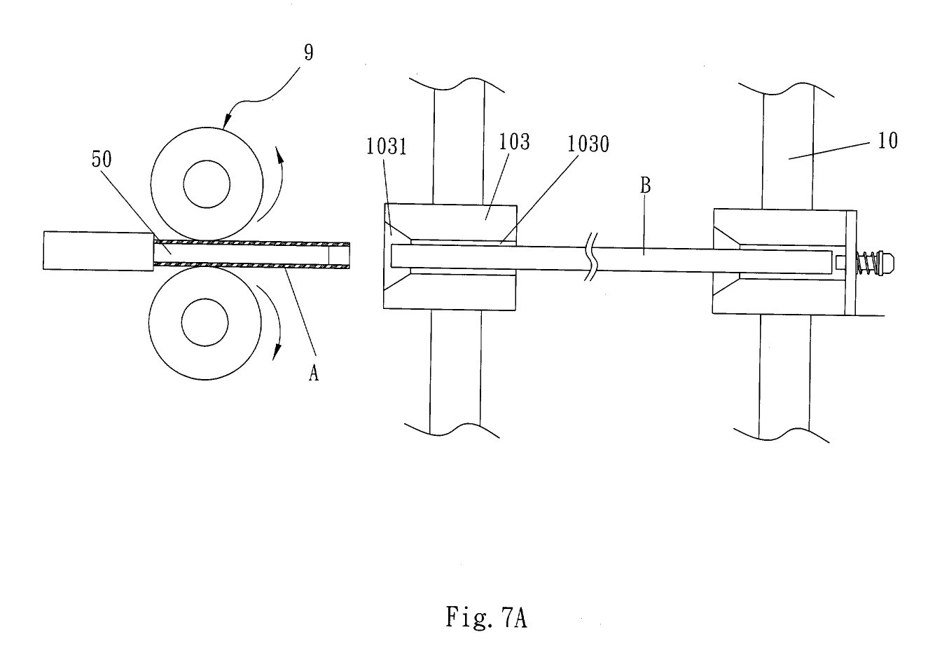

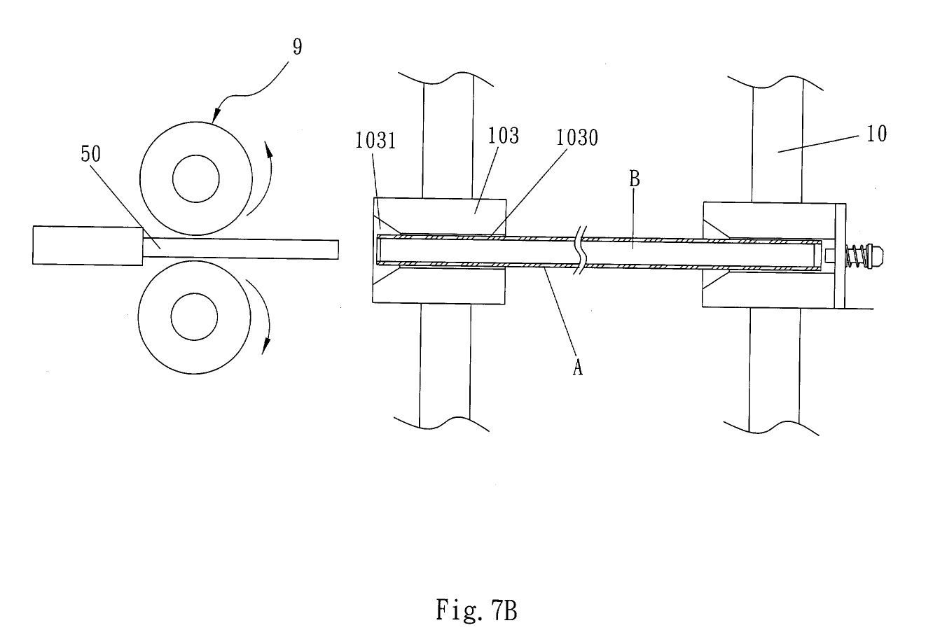

Please refer to FIGS. 1 and 2 for the present invention, comprising a machine base 1, a shrinkable film drum disposed on one side, a frame 3 disposed on the other side, a tension device 4 disposed therein, a movable base 5 disposed in the middle, a shrinkable film guide device 14 disposed adjacent to the movable base 5, a cutting device 8, a conveying wheel 10 disposed in front of the cutting device 8, and a feeding device 11 disposed on one side of the conveying wheel 10, an opening disposed on a front panel of the machine base 1 and large enough to let a conveying groove 12 with a thermal shrink device 13 be built outside, a shrinkable film drum 2, being a disc wheel and disposed on the machine base 1 for receiving a roll of shrinkable film when the drum is enclosed (as shown in FIG. 3A); a tension device 4 as shown in FIG. 3A installing two sets of alternately corresponding guide wheels 30 and guide rods 31 in the frame 3 and a control guide wheel 32 each on the inner and outer side of the tension device 4, and a positioning roller 320; such control guide wheel is coupled and linked to a controller; the controller senses the speed of transmission of the shrinkable film A and drives the control guide wheel 32 to move back and forth to adjust the transmission speed and quantity of the shrinkable film A. When the tension device 4 drops, it means the transmission speed of the shrinkable film is too slow and causes the central guide pillar 50 not to have enough quantity of the shrinkable film for storage and transmission. Therefore the controller 33 will notice the control guide wheel 32 to speed up the transmission of shrinkable film (as shown in FIG. 3C). On the other hand, when the tension device 4 rises, it means the transmission speed of the shrinkable film A is too fast, and causes the central guide pillar 50 unable to convey the shrinkable film. Therefore, the controller will notice the control guide wheel to gradually slow down the transmission of the shrinkable film A (as shown in FIG. 3C). A movable base 5 as shown in FIG. 2 being a base body 51 having a corresponsive guide wheel 510 protruded from the left and right ends and a placing member 511 protruded from the middle; such placing member 511 at both sides has a recession 512, and a roller 513 is disposed in the recession 512, such that the two rollers enable the central guide pillar 50 to convey the shrinkable film. The guide wheel 510 is a cylindrical object with flat ends, and has a plurality of guide wheels 500 (as shown in FIG. 4), and a contraction and expansion fine-tune device 7 and a vertical fine-tune device 6 on the left and right sides of a base body 1; the vertical fine-tune device 6 adjusts the height of elevation of the shrinkable film guide device 14 by a guide rod 60 above a fine-tune device 61 (as shown in FIG. 5A); the contractible fine-tune device 7 comprises a fine-tune device with a guide rod 70 and an externally connected handle 71, being disposed on the left side of the bottom of the movable base 5 for fine tuning the distance between the movable base 5 and the cutting device 8 (a shown in FIG. 5B). A knife 80 at the bottom can be adjusted vertically by a fine-tune device 81 under a handle 82, and is disposed on one side of the shrinkable film guide device 14 for cutting the shrinkable film A with a desired length. A high-speed wheel 9 disposed on one side of the cutting device 8 comprises two corresponding wheels of equal radii that rotate in the directions opposite to each other. A feeding wheel 10 (as show in FIG. 16) disposed on another sidewall of the upper section of the machine base 1 comprises two circular boards 101, 102, a through hole 1010, 1020 disposed at the middle section of the two circular boards 101, 102, a plurality of through holes 1011, 1021 and fixing holes 1013, 1023 equidistantly disposed around the periphery of the two circular boards 101, 102 and their corresponding cut openings 1012, 1022, A support member 103 is fixed equidistantly between two circular boards 101, 102, and such support member 103 has a support groove 1030 on its upper section and an aslant surface 1031 at its side for facilitating the conveying and wrapping of the shrinkable film A (as shown in FIGS. 7A, 7B). An embedding groove 1032 under the support member 103 is embedded into the cut openings 1012, 1022 of the two circular boards 101, 102. A blocking member 104 is disposed on one side of the support member 103 to block the shrinkable film A. A feeding device 11 disposed on a rear end of the machine base 1 comprises an accommodating groove 110, an aslant conveying groove 111 disposed inside the accommodating groove 110 for conveying a packing object that cannot be or uneasy to be placed vertically, a conveying groove 12 passing through the opening 100 at the front panel of the machine base 1, a thermal shrink device 13 disposed on the conveying groove 12, a shrinkable film guide device 14 in the tension device 4 and the cutting device 8, a pulling device 140, a pressing device 141 having a handle 1400, a fine-tune device 1401, a plurality of digital fine-tunes on the fine tune device, and a press guide wheel 1402 corresponsive to the guide wheel 500 of the central guide pillar 50; by means of the assembling of the foregoing components, the improved horizontal labeling machine according to the present invention is made.

Please refer to FIG. 2 for the application of the horizontal labeling machine according to the present invention. The shrinkable film A is placed onto a shrinkable film drum 2 after the drum is enclosed, and the shrinkable film A is disposed on the alternated guide wheel 30 in the frame 3 of the tension device 4, and then surrounds the control guide wheel 32 on one side, and passes through the central guide pillar 50 along the positioning rollers 320 disposed outside the frame 3. By means of the pulling device 140, the shrinkable film A is pulled onto the pressing device 141. After the folded edge of the shrinkable film A is pressed even, the pressed shrinkable film A will be sent to the cutting device for the cutting of a desired length. Then the shrinkable film A is spread over the packing object B on the feeding device 11. The conveying wheel 10 will send the packing object B down to the conveying groove 12 and up into the thermal shrinkable device 13 for the thermal shrinking.

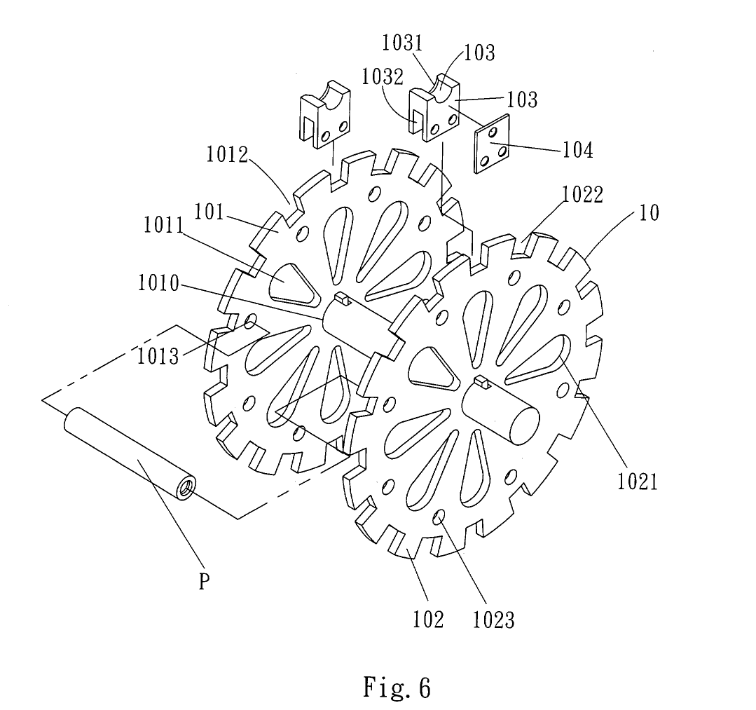

Please refer to FIG. 3A for the operation. The shrinkable film A is sent from the tension device 4 to the central guide pillar 50. The tension device 4 adjusts and controls the transmission speed and quantity of the shrinkable film A. When the tension device 4 drops, it means that the transmission speed of the shrinkable film A is too slow and causes the central guide pillar 50 not to have enough quantity of the shrinkable film for storage and transmission. Therefore, the control guide wheel 32 will speed up the shrinkable film (as shown in FIG. 3B). On the contrary, when the tension devices rises, it means that the transmission speed of the shrinkable film A is too fast and causes the central guide pillar 50 unable to store and convey the shrinkable film A. Therefore, the control guide wheel 32 will gradually slow down the transmission of the shrinkable film A (as shown in FIG. 3C). When the shrinkable film A is sent to the shrinkable film guide device 14, the shrinkable film A is spread out and pressed tightly such that the shrinkable film A is fully opened for sleeving onto the packing object. After that, the vertical and contraction and expansion fine-tune devices 6, 7 respectively disposed on one side and under the shrinkable film guide device 14 to adjust the vertical and contracted or expanded distance from the cutting device (as shown in FIGS. 5A and 5B). After the cutting device 8 cuts the shrinkable film into a desired length, the transmission of the high-speed wheel bases on the principle of centrifugal force to spread the shrinkable film onto the packing object B (as shown in FIG. 7) in the support groove 1030 of the support body 103 of the conveying wheel 10 (as shown in FIG. 6). An aslant surface 1031 is disposed on one side of the support body 103; after the shrinkable film A is spread out, the shrinkable film A can be quickly and accurately sleeved onto the packing object (as shown in FIG. 7B), and the packed object is sent to the conveying wheel 10 and then to the conveying groove 12. The thermal shrink device 13 shrinks the shrinkable film A to wrap film on the outer surface of the packing object B. The shrinkable film A can be automatically applied on a packing object that cannot be or is uneasy to be placed vertically, and the size of the gap between two circular boards 101, 102 of the conveying wheel 10 can be changed by the length of the axle rod P in order to adjust the length required for different packing object B.

What is claimed is:

1. An improved horizontal labeling machine, comprising:
a shrinkable film drum, being a disc-shaped drum and disposed on the upper section of a machine base for receiving a roll of shrinkable film after said shrinkable film drum being engaged;
a tension device, having two sets of alternated corresponding guide wheels and guide rods in a frame, and a control guide wheel and a positioning wheel respectively disposed on the inner and outer sides of said tension device;
a movable base, having a corresponding guide wheel each protruded from the left and right ends of a base body and a placing member protruded from the middle, and said placing member at both sides having a recession, and a roller being installed in each of said recessions, and said two rollers providing a transmission to a central guide pillar;
a vertical fine-tune device, using a guide rod at the upper section of the fine-tune device to adjust the vertical height of a shrinkable film guide mechanism;
a contraction and expansion fine-tune device comprising a guide rod and an externally connected handle, being disposed on the left side of the bottom of said movable base for fine tuning the distance between said movable base and a cutting device;
a cutting device, disposed on one side of the shrinkable film guide device for using a fine-tune device at the lower section of said handle to adjust the vertical movement of a knife;
a high-speed wheel, disposed on one side of said cutting device, comprising two corresponding wheels of equal radii rotating in the direction opposite to each other;
a conveying wheel, disposed on another sidewall of the upper section of said machine base, comprising two corresponding circular boards, and a through hole disposed at the center of said two circular boards and a plurality of through holes and fixing holes and a plurality of corresponding cut openings equidistantly disposed on the periphery of the two circular boards, and said two circular boards having a support body disposed equidistantly, and said support body having an embedding groove and a blocking member on one side to block and stop the shrinkable film;
a feeding device, disposed at one side of the rear end of said machine base, having an accommodating groove, and an aslant feeding groove disposed in the accommodating groove;
a conveying groove, passing through an opening on the front panel of said machine base;
a thermal shrink device, disposed in said tension device and said cutting device, comprising a pulling device and a pressing device both having a handle and a fine-tune device, and said fine-tune device having a digital fine-tune and a press guide wheel disposed at the lower section corresponding to the guide wheel of said central guide pillar for automatically sleeving said shrinkable film onto a packing object unable to be placed vertically by sending the shrinkable film to said conveying wheel by using said high-speed wheel.

2. The improved horizontal labeling machine of claim 1, wherein said control guide wheel is coupled to a controller and said controller is used to detect the acceleration and retardation of the transmission of said shrinkable film.

3. The improved horizontal labeling machine of claim 1, wherein said central guide pillar is a cylindrical body with flat ends and has a plurality of guide wheels on its periphery.
